(19) United States
(12) Patent Application Publication
(10) Pub. No.: US 2012/0206931 A1
(43) Pub. Date: Aug. 16, 2012

(54) VEHICLE LIGHTING DEVICE

(76) Inventors: Yoshiaki NAKAZATO, Yokohama-shi (JP); Yoshiaki NAKAYA, Yokohama-shi (JP)

(21) Appl. No.: 13/371,340

(22) Filed: Feb. 10, 2012

(30) Foreign Application Priority Data
Feb. 10, 2011 (JP) 2011-026682

(51) Int. Cl. F21V 9/16; B60Q 1/00; F21V 13/00

(52) U.S. Cl. 362/510

(57) ABSTRACT

A vehicle lighting device can include an LED light source having a light emitting surface, a laser light source, and a fluorescent body for emitting visible light in response to excitation light from the LED light source and the laser light source. The fluorescent body can have a rear surface formed to have substantially the same size as the light emitting surface, and a front surface located opposite the rear surface. The fluorescent body can be disposed on the light emitting surface such that the rear surface covers the whole light emitting surface. The fluorescent body can emit the visible light from the whole of the front surface, in response to the excitation light from the LED light source. The laser light source irradiates the excitation light to a portion on the front surface. The portion is to emit the visible light to a high illuminance area within a light distribution pattern.

This application claims the priority benefit under 35 U.S.C. §119 of Japanese Patent Application No. 2011-026682 filed on Feb. 10, 2011, which is hereby incorporated in its entirety by reference.

### FIELD

The presently disclosed subject matter presently disclosed subject matter relates to a vehicle lighting device.

### DESCRIPTION OF RELATED ART

In recent years, light sources with a light emitting diode (LED) are being increasingly applied to vehicle lighting devices such as headlamps for vehicles. Such vehicle lighting devices are superior in terms of power consumption, etc., but the brightness of an LED is lower than that of other light sources such as high intensity discharge (HID) lamps. Accordingly, the light distribution pattern (for example, the pattern of the low beam) which a vehicle lighting device of this type creates may exhibit insufficient illuminance at an area near the cut-off line, which is used to illuminate a distant area. In this case, it is difficult to provide sufficient visibility.

In order to cope with the above, for example, Japanese Patent Application Laid-Open No. 2010-232044 has disclosed a vehicle lighting device, which includes a board having multiple LED light sources and a fluorescent body thereon that is disposed behind and opposite a projection lens. In the device, the light from the LED light sources, which mainly creates the low-beam pattern, illuminates an area away from the cut-off line, while the light from the fluorescent body, which is excited by laser light, illuminates an area near the cut-off line. Since this vehicle lighting device illuminates the area near the cut-off line with the laser light that is brighter than the light from the LED light sources, sufficient illuminance is obtained in this area, so that a light distribution pattern (low-beam pattern) providing high visibility is created.

However, in the vehicle lighting device disclosed in Japanese Patent Application Laid-Open No. 2010-232044, the LED light sources and the fluorescent body, which are arranged on the board, create individual light pattern areas within the light distribution pattern. Accordingly, the gap between the LED light sources and the fluorescent body directly influences the light distribution pattern. Specifically, because of this gap, a low illuminance area may be created between a region near the cut-off line which is irradiated with the light from the fluorescent body, and another region which is irradiated with the light from the LED light sources. As a result, illumination nonuniformity may appear within the light distribution pattern.

In addition, the above vehicle lighting device disclosed in Japanese Patent Application Laid-Open No. 2010-232044 emits white light by combining blue laser light and yellow light from the fluorescent body excited by this blue laser light. When the laser light is irradiated on part of the fluorescent body, this laser light travels the interior of the fluorescent body, thus exciting the non-irradiated part of the fluorescent body. Consequently, while the part of the fluorescent body which is irradiated with the laser light emits white light as appropriate, the other non-irradiated part emits yellowish light that may not be sufficiently combined with the blue laser light. In this case, the whole of the fluorescent body emits the light partially containing color shading, and the light distribution pattern created by this light partially contains the color shading.

### SUMMARY

The presently disclosed subject matter has been conceived in consideration of the above characteristics and disadvantages, and aims to provide a vehicle lighting device which is capable of ensuring a high visibility, and creating a light distribution pattern containing little illumination nonuniformity and color shading.

According to an aspect of the presently disclosed subject matter, there is provided a vehicle lighting device, that can include: an LED light source having a light emitting surface; a laser light source; and a fluorescent body for emitting visible light in response to excitation light from the LED light source and the laser light source, the fluorescent body i) having a rear surface formed to have substantially the same size as the light emitting surface, and a front surface located opposite the rear surface, ii) disposed on the light emitting surface such that the rear surface covers the whole light emitting surface, and iii) emitting the visible light from the whole of the front surface, in response to the excitation light from the LED light source, wherein the laser light source irradiates the excitation light to a portion on the front surface, the portion being to emit the visible light to a high illuminance area within a light distribution pattern.

The portion of the fluorescent body can be thicker than the other portion of the fluorescent body.

The portion of the fluorescent body can have a fluorescent concentration higher than the other portion of the fluorescent body.

The vehicle lighting device can further include: a reflector for reflecting forward the visible light emitted from the fluorescent body; a projection lens for projecting the visible light reflected from the reflector onto a front area of a vehicle; and a shade for partially blocking the visible light which has been reflected from the reflector and which is to enter the projection lens.

The vehicle lighting device can further include a light-shielding member disposed adjacent to the fluorescent body so as to partially cover the front surface of the fluorescent body, and partially blocking the visible light emitted from the fluorescent body.

A vehicle lighting device according to one embodiment of the presently disclosed subject matter can include an LED light source, a laser light source, and a fluorescent body that emits visible light in response to excitation light from the LED light source and the laser light source. In addition, while the fluorescent body is emitting the visible light from a front surface thereof, the LED light source is irradiating a rear surface of the fluorescent body with the excitation light, and the laser light source is irradiating, with the excitation light (or laser light), a portion of the front surface of the fluorescent body which is to emit the visible light to a high illuminance area within a light distribution pattern. Consequently, the fluorescent body generates main visible light for creating the light distribution pattern, on the basis of the excitation light from the LED light source, as well as highly bright visible light for creating the high illuminance area within the light distribution pattern, on the basis of the excitation light from the laser light source. This makes it possible to create the high illuminance area, which illuminates a distant area, thus providing the sufficient visibility.

Furthermore, the rear surface of the fluorescent body is formed to have substantially the same size as a light emitting surface of the LED light source, and is disposed above the light emitting surface so as to cover this whole light emitting surface. In addition, the fluorescent body emits the visible light from the whole front surface located opposite the rear surface, in response to the excitation light from the LED light source. Therefore, the excitation light from the LED light source is irradiated throughout the fluorescent body through the rear surface. Consequently, the appropriately combined visible light is emitted from the whole front surface of the fluorescent body. This prevents color shading from appearing within the light distribution pattern.

Moreover, the fluorescent body is emitting the visible light from the whole front surface, while the laser light source is partially irradiating the front surface of the fluorescent body with the excitation light (or laser light). Therefore, the front surface of the fluorescent body, which creates a main light source image for the light distribution pattern, emits the especially bright light from the portion thereof on which the excitation light from the laser light source is irradiated, but the whole front surface of the fluorescent body emits the light without creating an unnaturally dark light region. Consequently, as opposed to related vehicle lighting devices in which an LED light source and a fluorescent body create individual regions within a light distribution pattern, the vehicle lighting device according to one embodiment of the presently disclosed subject matter is capable of preventing the gap between the LED light source and the fluorescent body from creating any dark light region within the light distribution pattern, thus restricting the occurrence of illumination nonuniformity within the light distribution pattern.

### BRIEF DESCRIPTION OF THE DRAWINGS

FIG. 1 is a front view illustrating a headlamp equipped with a vehicle lighting device according to a first or third embodiment of the presently disclosed subject matter;

FIG. 2 is a side cross section view illustrating the vehicle lighting device of the first embodiment;

FIG. 3 is a plane view illustrating a fluorescent body of the first embodiment;

FIG. 4 is a view illustrating a state where blue laser light is irradiated on the fluorescent body of the first embodiment;

FIGS. 5A and 5B are views illustrating the optical paths in the vehicle lighting device of the first embodiment;

FIG. 6 is a view illustrating a light distribution pattern created by the vehicle lighting device of the first embodiment;

FIG. 7 is a view illustrating a side cross section view illustrating a vehicle lighting device according to a second embodiment of the presently disclosed subject matter;

FIG. 8 is a plane view illustrating a fluorescent body of the second embodiment;

FIGS. 9A and 9B are views illustrating the optical paths in the vehicle lighting device of the second embodiment;

FIG. 10 is a side cross section view illustrating the vehicle lighting device of the third embodiment;

FIG. 11 is a plane view illustrating the fluorescent body of the third embodiment;

FIGS. 12A and 12B are views illustrating the optical paths in the vehicle lighting device of the third embodiment;

FIGS. 13A and 13B are views illustrating modifications of the fluorescent body according to an embodiment of the presently disclosed subject matter; and

FIGS. 14A and 14B are views illustrating modifications of the fluorescent body according to an embodiment of the presently disclosed subject matter.

### DESCRIPTION OF EXEMPLARY EMBODIMENTS

Exemplary embodiments of the presently disclosed subject matter will be described below, with reference to the accompany drawings.

In the embodiments, the descriptions of “top”, “bottom”, “front”, “rear”, “left” and “right” correspond to respective directions when viewed from vehicle lighting devices of the embodiments, unless otherwise specified, and these descriptions will be used corresponding to those in the drawings.

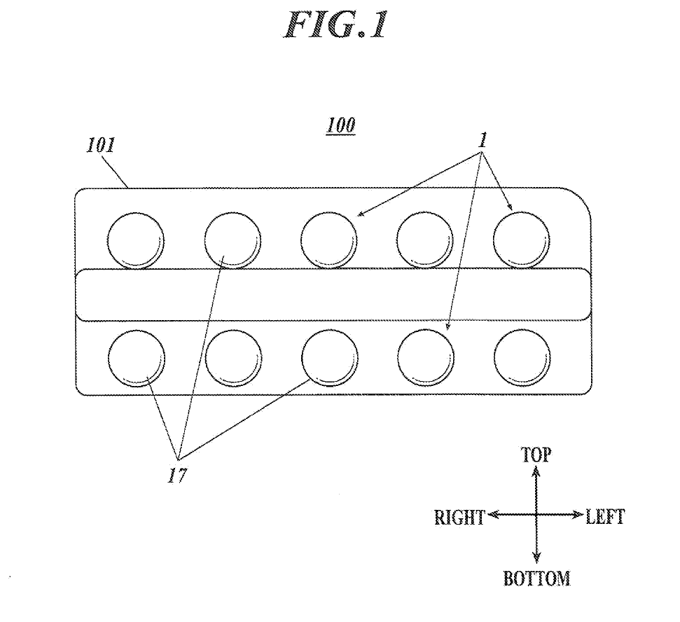

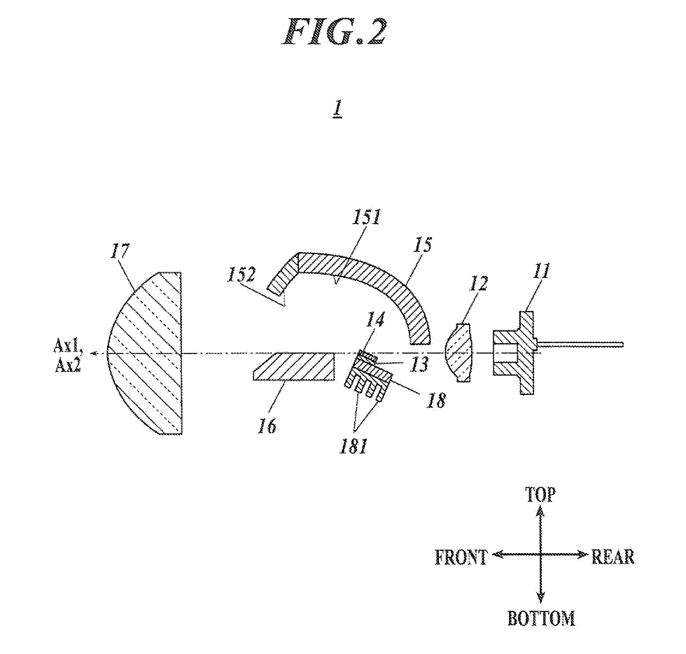

FIG. 1 is a front view illustrating a headlamp 100 equipped with a vehicle lighting device 1 according to a first embodiment of the presently disclosed subject matter, and FIG. 2 is a side cross section view illustrating the vehicle lighting device 1.

Referring to FIG. 1, the headlamp 100 is equipped with multiple vehicle lighting devices 1 in a lamp room having a front side covered with a transparent cover 101, and the light from each vehicle lighting device 1 creates a predetermined light distribution pattern (the pattern of a low-beam; thereinafter, called a “low-beam pattern”) on the front area of the vehicle.

Referring to FIG. 2, the vehicle lighting device 1 is a so-called projection type lighting device, and includes a laser diode (hereinafter, called an “LD”) 11, a condenser lens 12, two light emitting diodes (hereinafter, called “LEDs”) 13 and 13, a fluorescent body 14, a reflector 15, a shade 16, and a projection lens 17.

Specifically, the LD 11 has an optical axis Ax1 extending in the front-rear direction, and emits blue laser light forward on the optical axis Ax1, for exciting the fluorescent body 14. This LD 11 exhibits the brightness property of the gaussian distribution, which has the highest brightness at the center of the light-emitting portion.

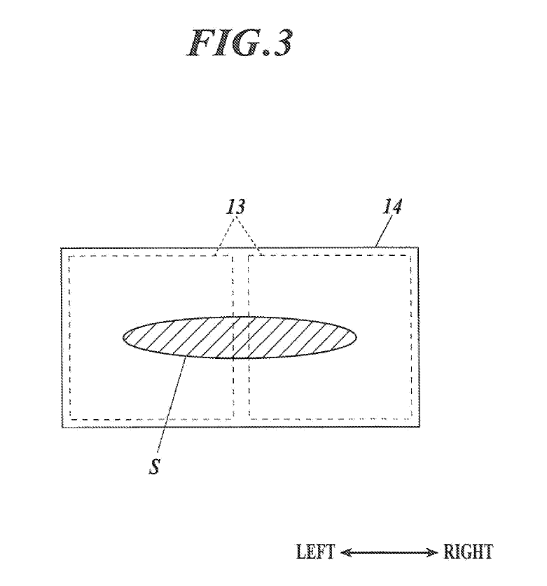

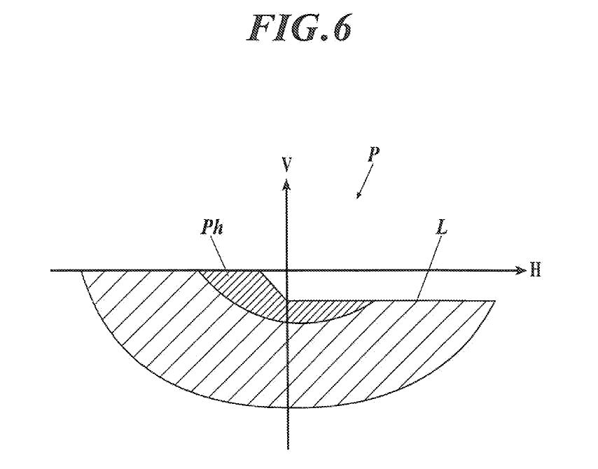

The condenser lens 12 is located in front of the LD 11, for focusing the blue laser light, which has been emitted forwardly from the LD 11, on the front (or upper) surface of the fluorescent body 14 located ahead of the condenser lens 12. Specifically, the condenser lens 12 focuses the blue laser light from the LD 11 on a laser irradiated region S (see FIG. 3) located substantially at the center of the front surface of the fluorescent body 14, thereby irradiating the laser irradiated region S. As will be described later, this laser irradiated region S on the front surface of the fluorescent body 14 serves the purpose of emitting white light toward a high illuminance area Ph within the light distribution pattern or low-beam pattern P (see FIG. 6).

Each of the LEDs 13 and 13 is formed of an LED chip of 1 mm per side, and emits blue light for exciting the fluorescent body 14. In addition, as illustrated in FIG. 3, the LEDs 13 and 13 are arranged across a gap of 0.1 mm in the right-left direction or in the vertical direction with respect to the sheet of FIG. 2. Each of the LEDs 13 and 13 is inclined toward the rear, while the light emitting surface on the upper surface forms an angle of 22.5 degrees with the optical axis Ax1. Furthermore, the LEDs 13 and 13 are mounted on an upper surface of a metal flat plate 18, and are disposed ahead of the condenser lens 12. On the lower surface of the metal flat plate 18 is a heat sinking fin 181 formed for dispersing the heat generated in the LEDs 13 and 13.

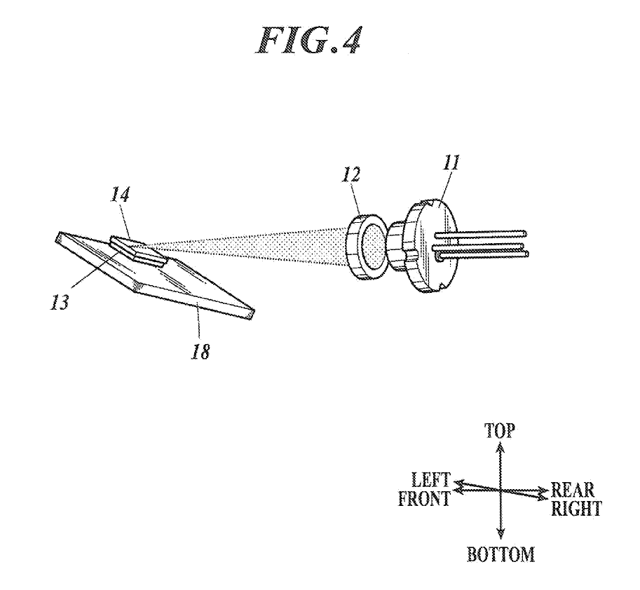

FIG. 3 is a plane view illustrating the fluorescent body 14, and FIG. 4 is a view illustrating a state where the LD 11 irradiates the fluorescent body 14 with the blue laser light.

Referring to these figures, the fluorescent body 14 has a flat plate shape having the front (or upper) surface and the rear (or lower) surface, each of which has substantially the same size, shape and area as the light emitting surface of both LEDs 13 and 13. In addition, the fluorescent body 14 is mounted above the light emitting surface of the LEDs 13 and 13 so as to be located on the optical axis Ax1. Accordingly, the front surface of the fluorescent body 14 is inclined toward the rear at an angle of 22.5 degrees with respect to the optical axis Ax1, similarly to the arrangement of the light emitting surface of the LEDs 13 and 13. In more detail, the front and rear surfaces of the fluorescent body 14 each have a rectangular shape, each side of which extends from the corresponding side or sides of the two LEDs 13 and 13 by approximately 0.05 mm. In addition, the fluorescent body 14 is disposed, while the rear surface thereof covering the light emitting surface of the LEDs 13 and 13. This fluorescent body 14 is made of a fluorescent material, and is excited by receiving the blue light emitted from the LD 11 and the LEDs 13 and 13, thereby emitting yellow light. When this fluorescent body 14 receives the blue light, the yellow light emitted from the fluorescent body 14 and the blue light scattered on the fluorescent body 14 are combined, so that white light is generated. This white light propagates in all upward directions from the front surface of the fluorescent body 14.

The reflector 15 has a curved plate shape having an aperture at the lower portion thereof, and is disposed so as to cover the fluorescent body 14 from the above, as illustrated in FIG. 2. This reflector 15 has a reflection surface 151 and a focusing reflection surface 152 on the lower surface thereof: the reflection surface 151 forwardly reflects the white light emitted from the fluorescent body 14; and the focusing reflection surface 152 reflects the blue laser light that has been reflected regularly from the front surface of the fluorescent body 14, while focusing the reflected light on the fluorescent body 14.

Specifically, the reflection surface 151 forms a sculptured surface based on a spheroid having a primary focal point at the position of the fluorescent body 14, and the reflection surface 151 is formed such that the eccentricity thereof is gradually becoming larger toward the lateral cross section from the vertical cross section. This reflection surface 151 is disposed facing the front (or upper) surface of the fluorescent body 14. When the white light from the fluorescent body 14 is irradiated on the vertical cross section of the reflection surface 151, the vertical cross section focuses the light at the position near the front end of the shade 16. As the position where the light is irradiated is moving toward the lateral cross section from the vertical cross section, the focal point of the reflected light is being shifted forward.

Meanwhile, the focusing reflection surface 152 is disposed ahead of and obliquely above the fluorescent body 14, namely, is positioned at an elevation angle of 45 degree with respect to the fluorescent body 14. In addition, the focusing reflection surface 152 is formed integrally with the front end of the reflection surface 151. This focusing reflection surface 152 functions as a reflection surface for focusing light on the fluorescent body 14. As will be described later, the focusing reflection surface 152 reflects the blue laser light that has been reflected regularly from the front surface of the fluorescent body 14 and has not become white light, and focuses this blue laser light on the fluorescent body 14, thereby irradiating the laser irradiated region S.

The shade 16 functions as a light-shielding member, and is disposed ahead of the fluorescent body 14. This shade 16 partially blocks the white light reflected from the reflection surface 151 of the reflector 15, thereby forming a cut-off line L on the low-beam pattern P (see FIG. 6). Then, the shade 16 partially blocks the white light, such that the white light emitted from the laser irradiated region S of the fluorescent body 14 illuminates the high illuminance area Ph of the low-beam pattern P, as will be described later. Moreover, the upper surface of the shade 16 is formed at substantially the same height as the optical axis Ax1, and is evaporated with aluminum. Therefore, when the white light that has been reflected from the reflection surface 151 is incident on the upper surface of the shade 16, the shade 16 reflects this incident light toward the projection lens 17 located ahead of the shade 16.

The projection lens 17 is formed of an aspherical plano-convex lens, having an optical axis Ax2 aligned with the optical axis Ax1 of the LD 11, and is located ahead of the reflector 15 and the shade 16. This projection lens 17 has a primary focal point positioned near the front end of the shade 16. When the white light reflected from the reflection surface 151 of the reflector 15 enters the projection lens 17, this projection lens 17 projects the light onto the front area of the vehicle.

Now, a description will be given an operation of the vehicle lighting device 1 upon generating the light distribution pattern, mainly, low-beam pattern.

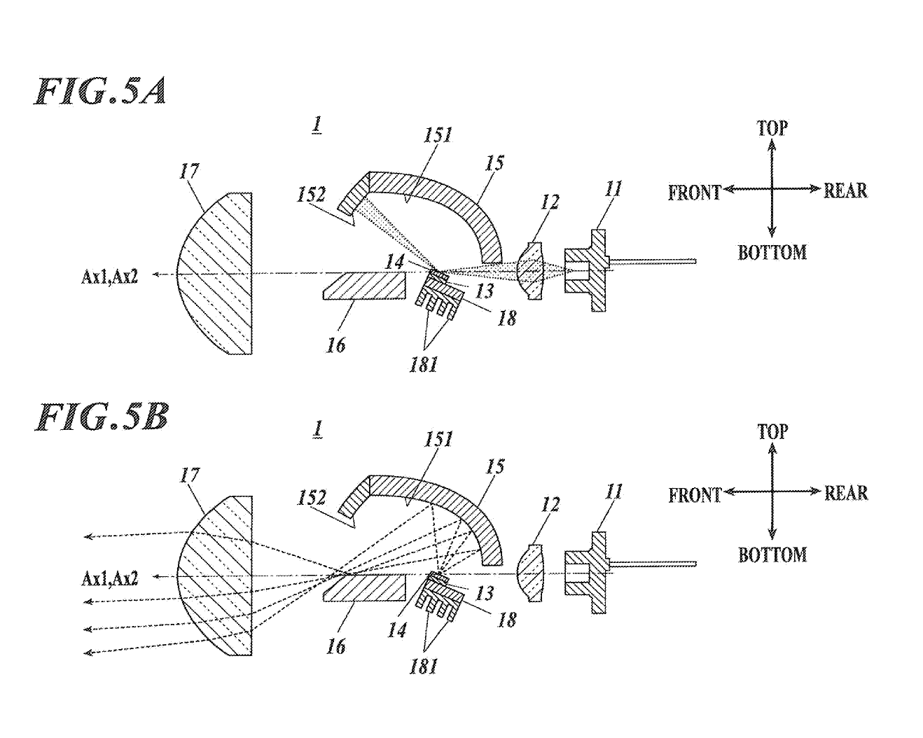

FIGS. 5A and 5B are views illustrating the optical paths in the vehicle lighting device 1, and FIG. 6 is a view illustrating the light distribution pattern or low-beam pattern appearing on a virtual screen disposed in front of the vehicle which vehicle lighting device 1 generates. Here, in FIG. 6, “H” denotes a horizontal direction and “V” denotes a vertical direction.

Referring to FIG. 5A, once the LD 11 and LEDs 13 and 13 emit light, the blue laser light from the LD 11 is focused by the condenser lens 12 and, then irradiated on the laser irradiated region S of the fluorescent body 14, while the blue light from the light emitting surface of the LEDs 13 and 13 enters the fluorescent body 14 through the rear surface.

The blue light from the LEDs 13 and 13 becomes white light by passing through the fluorescent body 14, and is emitted from the front surface of the fluorescent body 14. Since the front and rear surfaces of the fluorescent body 14 have substantially the same size as the light emitting surface of the LEDs 13 and 13, and the fluorescent body 14 is disposed while the rear surface thereof covering the whole light emitting surface of the LEDs 13 and 13, the blue light from the LEDs 13 and 13 is irradiated throughout the fluorescent body 14 through the rear surface. Accordingly, the white light which is generated on the basis of the blue light from the LEDs 13 and 13 is emitted from the whole front surface of the fluorescent body 14.

Meanwhile, the most of the blue laser light from the LD 11 becomes white light through the fluorescent body 14, and propagates upward from the laser irradiated region S of the fluorescent body 14. However, the part of this blue laser light does not become white light, and is reflected regularly from the inclined front surface of the fluorescent body 14 in the forward and obliquely upward direction. The part of the blue laser light that has been reflected from the front surface of the fluorescent body 14 is, in turn, focused by the focusing reflection surface 152 of the reflector 15, and is irradiated on the laser irradiated region S of the fluorescent body 14. As a result, the irradiated light becomes white light. In this state, the laser irradiated region S of the fluorescent body 14 emits not only the white light generated on the basis of the blue laser light that is brighter than the blue light from the LEDs 13 and 13, but also the white light generated on the basis of the blue light from the LEDs 13 and 13. Therefore, the light emitted from the laser irradiated region S of the fluorescent body 14 is brighter than that emitted from the other region thereof. Furthermore, as described above, the white light is emitted from the whole front surface of the fluorescent body 14, and the blue laser light is incident on only the laser irradiated region S. Therefore, although the laser irradiated region S on the front surface of the fluorescent body 14 emits the especially bright light, the whole of this front surface emits the light without creating any unnaturally dark light region.

Referring to FIG. 5B, the white light that has been emitted upward from the fluorescent body 14 is reflected forward by the reflection surface 151 of the reflector 15 and, then illuminates the front area of the vehicle through the projection lens 17. In this state, the part of the white light that is to enter the lower part of the projection lens 17 is blocked by the shade 16. In other words, the part of the light that is to illuminate the area above the cut-off line L is blocked. Consequently, the low-beam pattern as illustrated in FIG. 6 is generated. Furthermore, the highly bright white light from the laser irradiated region S that has been generated on the basis of the blue laser light illuminates the region of the low-beam pattern P which is located near the cut-off line L. Thus, the high illuminance area Ph is created near the cut-off line L.

As described above, the vehicle lighting device 1 emits the white light as main illumination light that has been generated on the basis of the blue light from the LEDs 13 and 13, thereby generating the low-beam pattern P. Also, the vehicle lighting device 1 emits the highly bright white light from the laser irradiated region S that has been generated on the basis of the blue laser light from the LD 11, thereby creating the high illuminance area Ph within the low-beam pattern P. This makes it possible to exhibit sufficient illuminance of the high illuminance area Ph, which illuminates a distant area, thus providing the sufficient visibility.

Moreover, since the blue light from the LEDs 13 and 13 is irradiated throughout the fluorescent body 14 through the rear surface thereof, the fluorescent body 14 emits the appropriately combined white light from the whole front surface. This prevents the color shading from appearing within the low-beam pattern P.

Furthermore, while the front surface of the fluorescent body 14, which is to create an optical image for the low-beam pattern P, emits the highly bright light from the laser irradiated region S, the whole of the front surface emits the light without creating any unnaturally dark portion thereon. Consequently, as opposed to related vehicle lighting devices in which an LED light source and a fluorescent body creates individual regions within a light distribution pattern, the vehicle lighting device of this embodiment is capable of preventing the gap between the LED light source and the fluorescent body from creating any dark light region within the light distribution pattern, thus restricting the occurrence of the illumination nonuniformity within the low-beam pattern P.

Next, a second embodiment of the presently disclosed subject matter will be described. Note that the same components as those in the first embodiment are given the same reference numerals, and the description thereof will not be repeated.

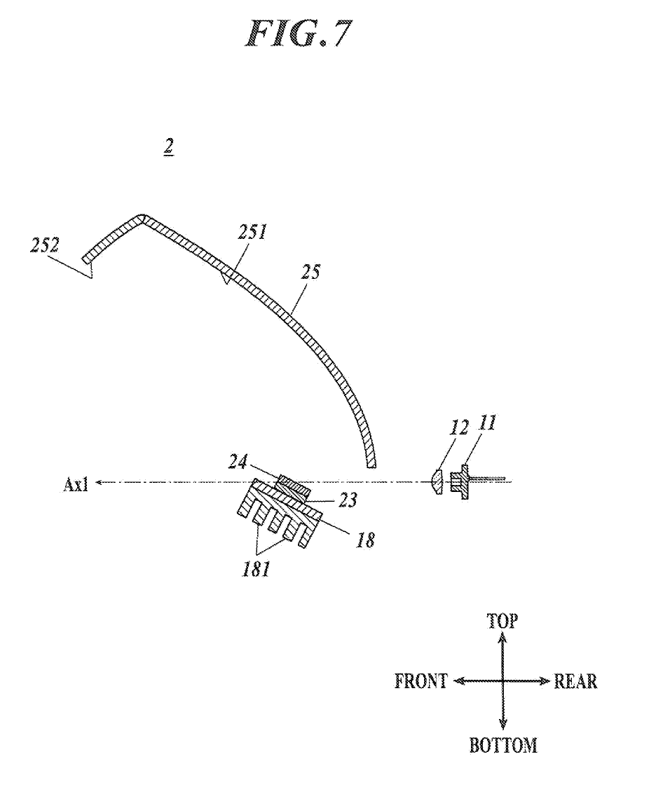

FIG. 7 is a side cross section view illustrating a vehicle lighting device 2 according to a second embodiment of the presently disclosed subject matter.

Referring to this figure, the vehicle lighting device 2 is a so-called parabolic lighting device, including an LD 11 and a condenser lens 12 that have the same structures as those in the first embodiment, together with two LEDs 23 and 23, a fluorescent body 24, and a reflector 25.

The LEDs 23 and 23 are arranged in the right-left direction or in the vertical direction with respect to the sheet of FIG. 7, and are inclined toward the rear at an angle of 27.5 degrees with respect to the optical axis Ax1. The other arrangements of the LEDs 23 and 23 are the same as those of the LEDs 13 and 13 of the first embodiment.

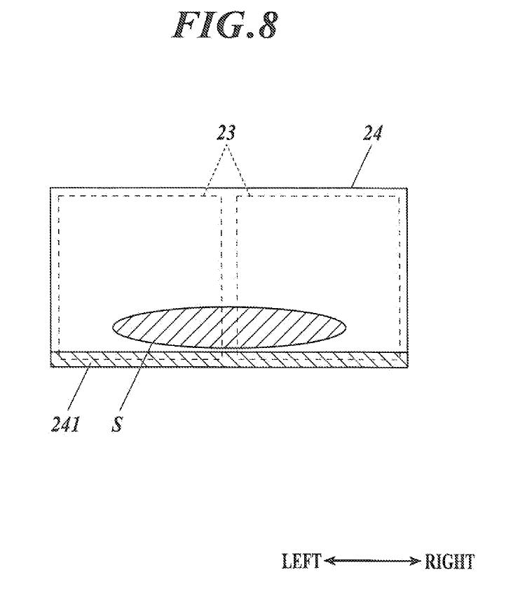

FIG. 8 is a plane view illustrating the fluorescent body 24.

Referring to this figure, the fluorescent body 24 has a similar structure to the fluorescent body 14 of the first embodiment. However, the fluorescent body 24 has a laser irradiated region S, on which blue laser light is to be irradiated, on the lower portion of the front surface thereof. In addition, the front surface of the fluorescent body 24 is covered by a light-shielding mask 241, such that the portion below the laser irradiated region S is behind this light-shielding mask 241.

The reflector 25 has a curved plate shape having an aperture at the lower portion thereof, and is disposed so as to cover the fluorescent body 24 from the above, as illustrated in FIG. 7. This reflector 25 includes a reflection surface 251 and a focusing reflection surface 252 on the lower surface thereof: the reflection surface 251 forwardly reflects the white light emitted from the fluorescent body 24; and the focusing reflection surface 252 reflects the blue laser light reflected regularly from the front surface of the fluorescent body 24 while focusing the reflected light on the fluorescent body 24.

Specifically, the reflection surface 251 forms a sculptured surface based on a paraboloid of revolution having a focal point at the position of the fluorescent body 24, and is disposed facing the front (or upper) surface of the fluorescent body 24.

Meanwhile, the focusing reflection surface 252 is disposed ahead of and obliquely above the fluorescent body 24, namely, at an elevation angle of 55 degree with respect to the fluorescent body 24. In addition, the focusing reflection surface 252 is formed integrally with the front end of the reflection surface 251. This focusing reflection surface 252 functions as a reflection surface having a focal point at the position of the fluorescent body 24.

Now, a description will be given of an exemplary operation of the vehicle lighting device 2 upon generating the light distribution pattern, mainly, low-beam pattern.

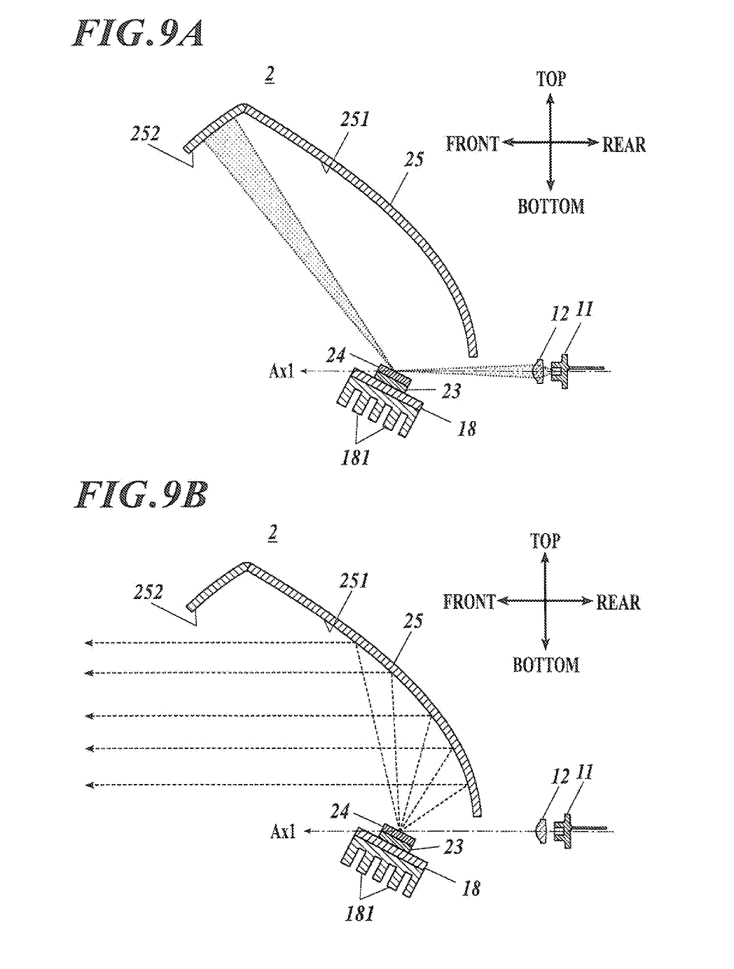

FIGS. 9A and 9B are views illustrating the optical paths in the vehicle lighting device 2.

Referring to FIG. 9A, once the LD 11 and LEDs 23 and 23 emit light, the blue laser light from the LD 11 is focused by the condenser lens 12 and, then irradiated on the laser irradiated region S on the front surface of the fluorescent body 24, while the blue light from the light emitting surface of the LEDs 23 and 23 enters the fluorescent body 24 through the rear surface.

The blue light from the LEDs 23 and 23 becomes white light by passing through the fluorescent body 24, and is emitted upward from the front surface of the fluorescent body 24. Moreover, since the blue light from the LEDs 23 and 23 is irradiated throughout the fluorescent body 24, the fluorescent body 24 emits, from the whole front surface, white light generated on the basis of the blue light, similarly to the fluorescent body 14 of the first embodiment.

Meanwhile, most of the blue laser light from the LD 11 becomes white light through the fluorescent body 24, and propagates upward from the laser irradiated region S of the fluorescent body 24. However, part of this blue laser light does not become white light, and is reflected regularly from the inclined front surface of the fluorescent body 24 in the forward and obliquely upward direction. The part of the blue laser light that has been reflected regularly from the front surface of the fluorescent body 24 is, in turn, focused by the focusing reflection surface 252 of the reflector 25, and is irradiated on the laser irradiated region S of the fluorescent body 24. As a result, the irradiated light becomes white light. In this state, the part of the light that is emitted from the laser irradiated region S of the fluorescent body 24 is brighter than the other part of the light, similarly to the light emitted from the laser irradiated region S of the first embodiment. In addition, the whole front surface of the fluorescent body 24 emits the light without creating any unnaturally dark portion thereon, similarly to the front surface of the fluorescent body 14 of the first embodiment.

Referring to FIG. 9B, the white light that has been emitted upward from the fluorescent body 24 is reflected forward by the reflection surface 251 of the reflector 25 and, then illuminates the front area of the vehicle. In this state, the white light that has been emitted from the front surface of the fluorescent body 24 is partially blocked by the light-shielding mask 241. In other words, the upper part of the light that is to illuminate the area above the cut-off line L is blocked. Consequently, the low-beam pattern P as illustrated in FIG. 6 is generated. Furthermore, the highly bright white light from the laser irradiated region S that has been generated on the basis of the blue laser light illuminates the region of the low-beam pattern P which is located near the cut-off line L. Thus, the high illuminance area Ph is created near the cut-off line L.

As described above, the vehicle lighting device 2 can produce the same effect as the vehicle lighting device 1 of the first embodiment.

Next, a third embodiment of the presently disclosed subject matter will be described.

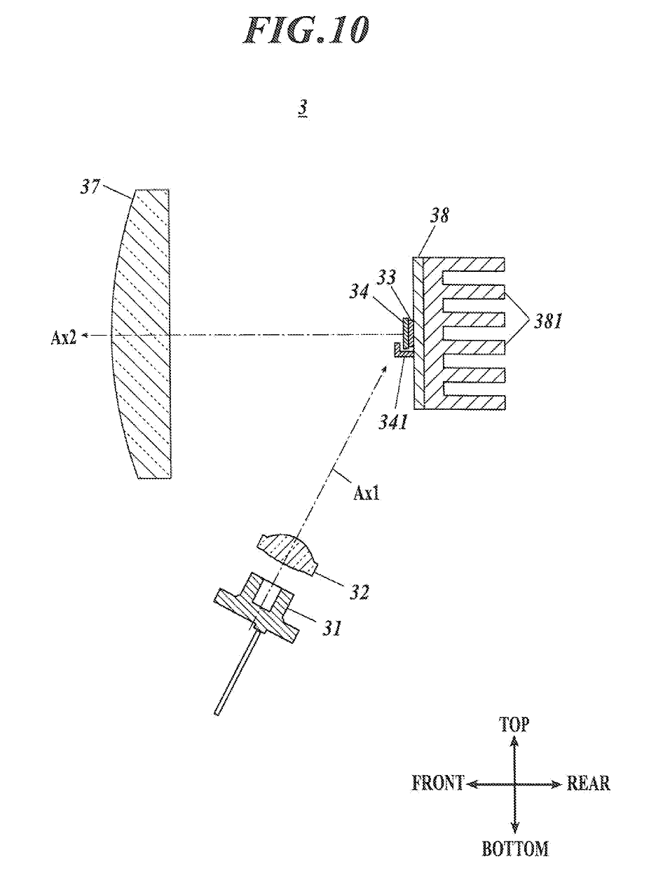

FIG. 10 is a view illustrating a side cross section view illustrating a vehicle lighting device 3 according to the third embodiment of the presently disclosed subject matter.

Referring to this figure, the vehicle lighting device 3 is a so-called direct-projection type lighting device, including an LD 31 and a condenser lens 32, two LEDs 33 and 33, a fluorescent body 34, and a projection lens 37.

Specifically, the LD 31 has an optical axis Ax1 extending in the rear and obliquely upward direction, and emits blue laser light on the optical axis Ax1 in the rear and obliquely upward direction, for exciting the fluorescent body 34. This LD 31 exhibits the brightness property of the gaussian distribution, which has the highest brightness at the center of the light-emitting portion.

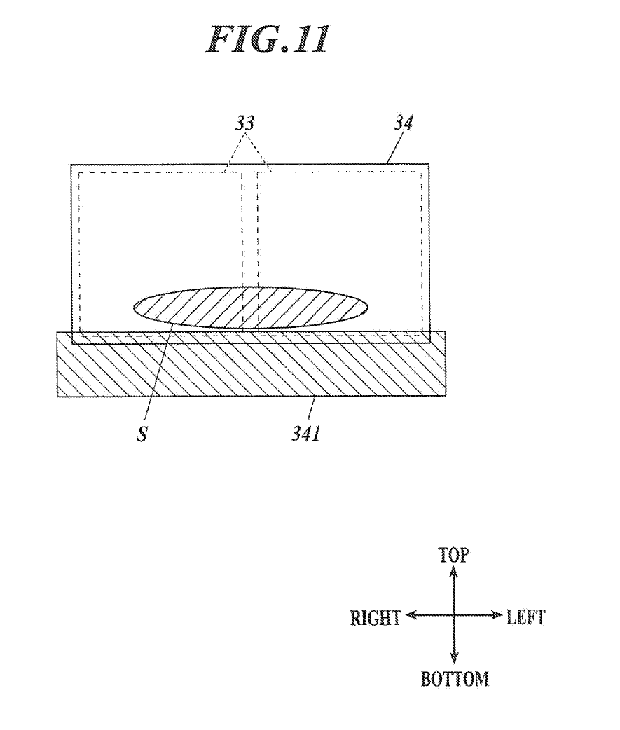

The condenser lens 32 is located on the optical axis Ax1 in the rear and obliquely upward direction with respect to the LD 31. In addition, the condenser lens 32 focuses the blue laser light, which has been emitted from the LD 31 in the rear and obliquely upward direction, on the front (or upper) surface of the fluorescent body 34 located in the rear of and obliquely upward with respect to the condenser lens 32. Specifically, the condenser lens 32 focuses the blue laser light from the LD 31 on a laser irradiated region S (see FIG. 11) located at the lower portion of the front surface of the fluorescent body 34, thereby irradiating the laser irradiated region S.

Each of the LEDs 33 and 33 is formed of an LED chip of 1 mm per side, and emits blue light for exciting the fluorescent body 34. In addition, as illustrated in FIG. 11, the LEDs 33 and 33 are arranged across a gap of 0.1 mm in the right-left direction or in the vertical direction with respect to the sheet of FIG. 10. Each of the LEDs 33 and 33 has a rear surface supported by a metal flat plate 38, so as to be located on the optical axis Ax1 and in the rear and obliquely upward direction with respect to the condenser lens 32, while a light emitting surface thereof facing in front. The metal flat plate 38 is disposed extending in the direction perpendicular to the front-rear direction. In addition, a front surface of the metal flat plate 38 supports the LEDs 33 and 33, while a rear surface thereof is provided with a heat sinking fin 381.

FIG. 11 is a plane view illustrating the fluorescent body 34.

The fluorescent body 34 is made of a fluorescent material, similar to the fluorescent body 14 of the first embodiment, and is mounted above the light emitting surface of the LEDs 33 and 33 so as to be located on the optical axis Ax1, as illustrated in FIG. 11. This fluorescent body 34 is configured to have the same positioning manner for the LEDs 33 and 33, dimensions, etc. as the fluorescent body 14 of the first embodiment. In addition, the fluorescent body 34 is disposed while the rear surface thereof covering the whole light emitting surface of the LEDs 33 and 33, and the front surface thereof being oriented in front. Moreover, the front surface of the fluorescent body 34 is covered by a light-shielding member 341 located close to the fluorescent body 34, such that the portion below the laser irradiated region S is behind this light-shielding member 341. This light-shielding member 341 has an L shape as viewed from the side, and a base portion thereof is fixed to the metal flat plate 38.

Referring to FIG. 10, the projection lens 37 is formed of an aspherical plano-convex lens having an optical axis Ax2 extending in the front-rear direction, and is located ahead of the fluorescent body 34 such that the fluorescent body 34 is located on the optical axis Ax2. This projection lens 37 has a primary focal point positioned near the fluorescent body 34. When the white light emitted from the front surface of the fluorescent body 34 enters the projection lens 37, this projection lens 37 invertedly projects the white light onto the front area of the vehicle.

Now, a description will be given an exemplary operation of the vehicle lighting device 3 upon generating the light distribution pattern, mainly, low-beam pattern.

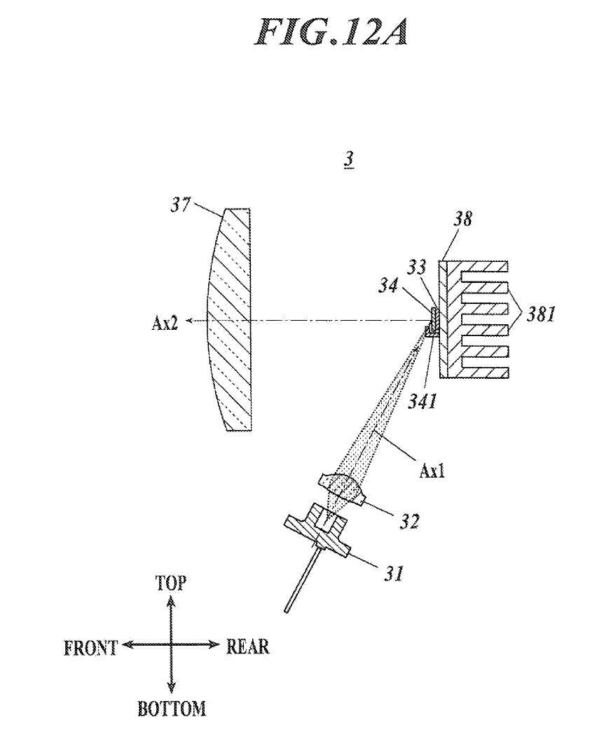

FIGS. 12A and 12B are views illustrating the optical paths in the vehicle lighting device 3.

Referring to FIG. 12A, once the LD 31 and LEDs 33 and 33 emit light, the blue laser light from the LD 31 is focused by the condenser lens 32 and, then irradiated on the laser irradiated region S of the fluorescent body 34, while the blue light from the light emitting surface of the LEDs 33 and 33 enters the fluorescent body 34 through the rear surface.

The blue light from the LEDs 33 and 33 becomes white light by passing through the fluorescent body 34, and is emitted from the front surface of the fluorescent body 34. Moreover, the blue light from the LEDs 33 and 33 is irradiated throughout the fluorescent body 34, similarly to the fluorescent body 14 of the first embodiment. Accordingly, the fluorescent body 34 emits, from the whole front surface thereof, white light that has been generated on the basis of the blue light from the LEDs 33 and 33.

Meanwhile, the blue laser light from the LD 31 becomes white light through the fluorescent body 34, and propagates forward from the laser irradiated region S of the fluorescent body 34. In this state, the part of the light that is emitted from the laser irradiated region S of the fluorescent body 34 is brighter than the other part of the light, similarly to the light emitted from the laser irradiated region S of the first embodiment. In addition, the whole front surface of the fluorescent body 34 emits the light without creating an unnaturally dark portion thereon, similar to the front surface of the fluorescent body 14 of the first embodiment.

Referring to FIG. 12B, the white light that has been emitted forward from the fluorescent body 34 illuminates the front area of the vehicle through the projection lens 37. In this state, the white light from the front surface of the fluorescent body 34 is partially blocked by the light-shielding member 341. In other words, the upper part of the light that is to illuminate the area above the cut-off line L is blocked. Consequently, the low-beam pattern P as illustrated in FIG. 6 is generated. Furthermore, the highly bright white light from the laser irradiated region S that has been generated on the basis of the blue laser light illuminates the region of the low-beam pattern P which is located near the cut-off line L. Thus, the high illuminance area Ph is created near the cut-off line L.

As described above, the vehicle lighting device 3 can produce the same effect as the vehicle lighting device 1 of the first embodiment.

The interpretation of the presently disclosed subject matter should not be limited to the above described first to third embodiments, and various modifications and variations to the presently disclosed subject matter can be made as appropriate.

For example, in the above first to third embodiments, the vehicle lighting devices 1 to 3 have been applied to create the low-beam pattern P. However, these lighting devices are also applicable to create a high-beam pattern.

In addition, although each pair of the LDs 11, 11 and 31, 31 emits the blue light, and each of the fluorescent bodies 14, 24 and 34 emits yellow light in response to the blue light, the presently disclosed subject matter is not limited to these configurations. Alternatively, another configuration for generating white light, and a combination of exciting light and a fluorescent body may be employed. Furthermore, the light emitted from each of the fluorescent bodies 14, 24 and 34 is not limited to the white light, and may be another colored visible light.

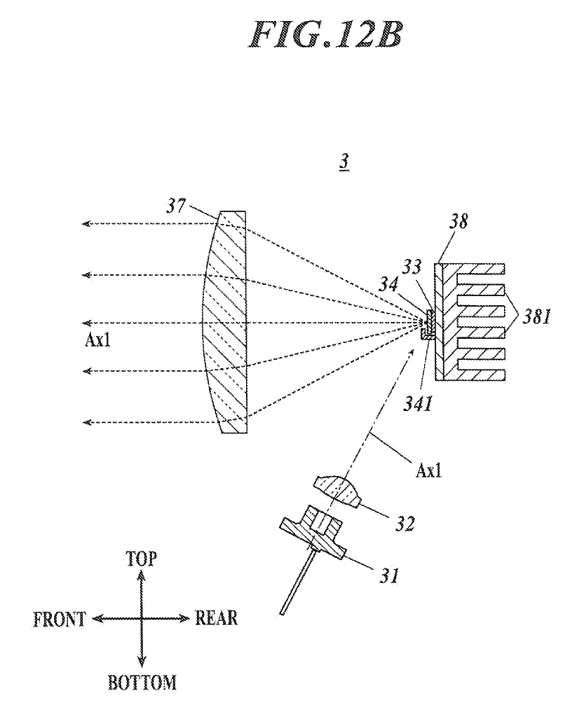

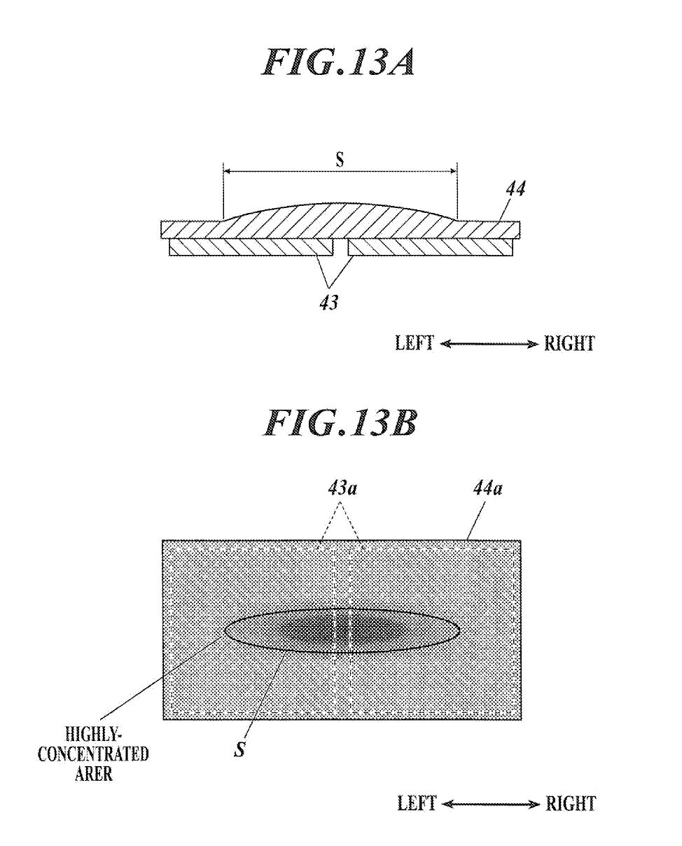

Moreover, any of the fluorescent bodies 14, 24 and 34 has the flat plate shape, but this body shape possibly generates color shading in the white light, if the irradiated blue light has a certain intensity distribution. Therefore, it is contemplated that any of the fluorescent bodies 14, 24 and 34 can have a nonuniform thickness in accordance with the intensity distribution of the irradiated blue light. In this case, each of the fluorescent bodies 14, 24 and 34 is formed to have the greater thickness at the location where the blue light of the higher intensity is irradiated. Accordingly, the laser irradiated region S of each of the fluorescent bodies 14, 24 and 34 can be thicker than another region thereof. Because the LDs 11 to 31 have the brightness property of the gaussian distribution, the laser irradiated region S of each of the fluorescent bodies 14, 24 and 34 on which the blue laser light from the LD 11 or 31 is irradiated can be thicker toward the center from the perimeter thereof (see FIG. 13A, for example).

Furthermore, each of the fluorescent bodies 14, 24 and 34 can have a fluorescent concentration, which means the concentration of fluorescent particles in binder, in accordance with the intensity distribution of the irradiated blue light, for the purpose of restricting the occurrence of the color shading in the white light. In this case, each of the fluorescent bodies 14, 24 and 34 has the greater or higher fluorescent concentration at the location where the blue light of the higher intensity is irradiated. Therefore, the portion of each of the fluorescent bodies 14, 24 and 34 on which the blue light from the LD 11 or 31 is irradiated can be thicker than the other portion (see FIG. 13B, for example).

Although the front surfaces of the fluorescent bodies 14, 24 and 34 are formed to have substantially the same size, shape and area viewed from front as the light emitting surface of the LEDs 13 and 13, 23 and 23, and 33 and 33, respectively, the fluorescent body is not limited to this structure. The fluorescent body may have any given structure, as long as emitting, from the whole of the front surface, the white light that has been generated on the basis of the blue light from each pairs of the LEDs 13 and 13, 23 and 23, and 33 and 33.

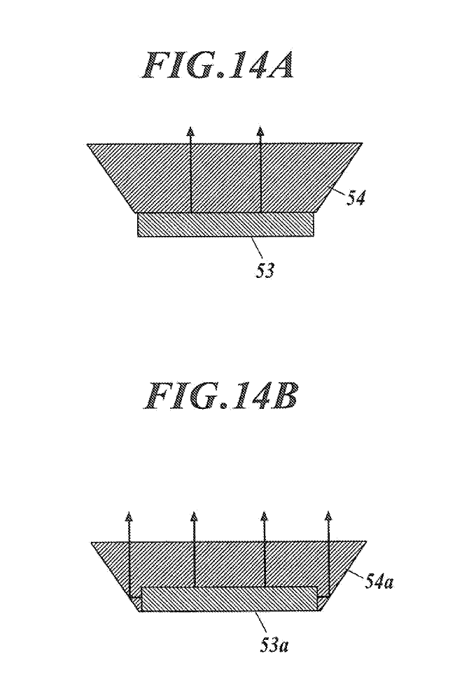

For example, the fluorescent bodies 14, 24 and 34 may have a front surface larger than or at least the same size as the whole light emitting surface of the LEDs 13 and 13, 23 and 23, and 33 and 33, respectively, and the front and rear surfaces thereof may be joined together through the tapered surrounding surface (see FIGS. 14A and 14B, for example). Even if the fluorescent bodies 14, 24 and 34 have such a structure, the fluorescent bodies 14, 24 and 34 are able to appropriately receive the blue light emitted radially from the light emitting surface of the LEDs 13 and 13, 23 and 23, and 33 and 33, respectively, and to emit, from the whole front surface thereof, the white light generated on the basis of the blue light. In this case, the rear surface, including the edge portions, of the fluorescent bodies 14, 24 and 34 may be disposed so as to cover the whole light emitting surface of the LEDs 13 and 13 to 33 to 33, respectively. In this arrangement, the fluorescent bodies 14, 24 and 34 capture even the blue light emitted from the sides of the LEDs 13 and 13 to 33 to 33, respectively, then the tapered surrounding surface reflects the captured blue light toward the front surface, and emits white light from the perimeter of the front surface.

Moreover, in each embodiment, these two LEDs 13 and 13, 23 to 23 or 33 to 33 are arranged, but the number of the arranged LEDs may be one or more than two. Note that if more than two LEDs 13, 13 and 13, 23, 23 and 23, or 33, 33 or 33 are used, then the fluorescent body 14, 24 or 34 can be disposed so as to cover the whole light emitting surface of the LEDs.

The entire disclosure of Japanese Patent Application No. 2011-026682 filed on Feb. 10, 2011 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

1. A vehicle lighting device, comprising:
an LED light source having a light emitting surface;
a laser light source; and
a fluorescent body configured to emit visible light in response to excitation light from the LED light source and the laser light source, the fluorescent body
i) having a rear surface substantially the same size as the light emitting surface, and a front surface located opposite the rear surface,
ii) disposed on the light emitting surface such that the rear surface covers the whole light emitting surface, and
iii) configured to emit visible light from the whole of the front surface, in response to the excitation light from the LED light source,
wherein the laser light source is configured to irradiates the excitation light to a portion on the front surface, the portion being configured to emit the visible light to a high illuminance area within a light distribution pattern.

2. The vehicle lighting device according to claim 1, wherein the portion of the fluorescent body is thicker than an other portion of the fluorescent body.

3. The vehicle lighting device according to claim 1, wherein the portion of the fluorescent body has a fluorescent concentration higher than an other portion of the fluorescent body.

4. The vehicle lighting device according to claim 1, further comprising:
a reflector configured to reflect the visible light emitted from the fluorescent body forward;
a projection lens configured to project the visible light reflected from the reflector onto a front area of a vehicle; and
a shade configured to partially block the visible light which has been reflected from the reflector and which is to enter the projection lens.

5. The vehicle lighting device according to claim 1, further comprising,
a light-shielding member disposed adjacent to the fluorescent body so as to partially cover the front surface of the fluorescent body, and so as to partially block the visible light emitted from the fluorescent body.
